(19) United States
(12) Patent Application Publication
(10) Pub. No.: US 2025/0009029 A1
(43) Pub. Date: Jan. 9, 2025

(54) AEROSOL GENERATION APPARATUS, INDUCTION COIL, AND PREPARATION METHOD THEREFOR

(71) Applicant: SHENZHEN FIRST UNION TECHNOLOGY CO., LTD., Shenzhen, Guangdong Province (CN)

(72) Inventors: Zuqiang QI, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/705,529

(22) PCT Filed: Nov. 9, 2022
(86) PCT No.: PCT/CN2022/130933

§ 371 Date: Apr. 27, 2024

(30) Foreign Application Priority Data
Nov. 9, 2021 (CN) 202111318784.9
Oct. 31, 2022 (CN) 202211351480.7

(51) Int. Cl. A24F 40/465; A24F 40/10; H05B 6/10

(52) U.S. Cl. CPC A24F 40/465; A24F 40/10; H05B 6/108

(57) ABSTRACT

An aerosol generation apparatus includes: an induction coil, configured to generate a changing magnetic field; and a susceptor, configured to be induced to produce heat in the changing magnetic field, to heat an aerosol generation substrate, to generate an aerosol. A wire material of the induction coil includes at least two wire cores, and the wire core includes at least two conductive wires, to suppress self-formed current deviation and reduce an internal loss of the induction coil. Alternatively, the wire material of the induction coil includes a plurality of wire cores, each wire core is formed by twisting a plurality of conductive wires one or more times, and 3 to 20 conductive wires are used in first twisting of the plurality of conductive wires, to avoid wire breakage, reduce alternating current impedance of the induction coil, and reduce a loss caused by an internal proximity effect.

### CROSS-REFERENCE TO RELATED APPLICATIONS

This application claims priority to Chinese Patent Application No. 202111318784.9, filed with the China National Intellectual Property Administration on Nov. 9, 2021 and entitled “AEROSOL GENERATION APPARATUS AND INDUCTION COIL”, which is incorporated herein by reference in its entirety.

This application further claims priority to Chinese Patent Application No. 202211351480.7, filed with the China National Intellectual Property Administration on Oct. 31, 2022 and entitled “ELECTRONIC ATOMIZATION DEVICE, INDUCTION COIL, AND METHOD THEREFOR”, which is incorporated herein by reference in its entirety.

### TECHNICAL FIELD

Embodiments of the present invention relate to the field of electronic atomization technologies, and in particular, to an aerosol generation apparatus, an induction coil, and a preparation method therefor.

### BACKGROUND

During use of tobacco products (such as cigarettes and cigars), tobacco is burnt to produce tobacco smoke. Attempts are made to replace these tobacco-burning products by making products that release compounds without burning. An example of such products is a heating device that releases compounds by heating rather than burning materials. For example, the materials may be tobacco or other non-tobacco products. These non-tobacco products may include or not include nicotine.

The aerosol generation apparatus, as a known heating device, can generate a magnetic field by using an induction coil. The magnetic field induces a susceptor to produce heat, to heat and atomize a liquid substrate and release compounds to generate an aerosol for inhalation by a user.

However, during production of an induction coil of an existing aerosol generation apparatus, because the induction coil is prepared from one or more thin conductive wires, it is prone to wire breakage in a twisting process. In addition, since alternating current impedance of the coil is large, the aerosol generation apparatus is less efficient in producing heat.

### SUMMARY

According to a first aspect of this application, an aerosol generation apparatus is provided, including: an induction coil, configured to generate a changing magnetic field; and a susceptor, configured to be induced to produce heat in the changing magnetic field, to heat an aerosol generation substrate to generate an aerosol, where a wire material of the induction coil includes at least two wire cores; and the wire core includes at least two conductive wires.

In a more preferred implementation, a cross section of a conductive material of the induction coil is circular or rectangular.

In a more preferred implementation, the induction coil is constructed into a solenoid coil or a planar spiral coil.

In a more preferred implementation, the wire material of the induction coil includes 3 to 10 wire cores.

In a more preferred implementation, the conductive wire has a diameter ranging from 0.02 mm to 0.2 mm.

In a more preferred implementation, the conductive wire has an elongation at break ranging from 1% to 6%.

In a more preferred implementation, the wire core has an ultimate tensile strength of more than 50 MPa.

In a more preferred implementation, the at least two conductive wires in the wire core are twisted; and/or the at least two wire cores in the wire material of the induction coil are twisted.

In a more preferred implementation, the wire core further includes a first cladding layer configured to cover the at least two conductive wires; and/or the induction coil further includes a second cladding layer configured to cover the at least two wire cores.

In a more preferred implementation, the aerosol generation substrate includes a liquid substrate, the susceptor is configured to heat the liquid substrate to generate an aerosol, each wire core is formed by twisting a plurality of conductive wires one or more times, and a number of conductive wires used in first twisting of the plurality of conductive wires ranges from 3 to 20.

In a more preferred implementation, the wire core is formed by twisting a plurality of conductive wires three or four times.

In a more preferred implementation, a diameter of the conductive wire ranges from 0.01 mm to 0.05 mm.

In a more preferred implementation, the wire material of the induction coil includes 500 to 2,000 conductive wires.

In a more preferred implementation, a working frequency provided for the induction coil ranges from 500 KHz to 3 MHz.

In a more preferred implementation, the induction coil is formed into a solenoid coil, and a number of turns of the solenoid coil ranges from 4 to 20.

In a more preferred implementation, a cross section of a hollow part of the solenoid coil is elliptical.

In a more preferred implementation, a spacing between adjacent turns of the solenoid coil ranges from 0.1 mm to 2 mm.

According to a second aspect of this application, an induction coil used in an aerosol generation apparatus is provided. The induction coil is configured to generate a changing magnetic field. a wire material of the induction coil includes a plurality of wire cores, and each wire core is formed by twisting a plurality of conductive wires one or more times, where a number of conductive wires used in first twisting of the plurality of conductive wires ranges from 3 to 20.

According to a third aspect of this application, a preparation method for an induction coil used in an aerosol generation apparatus is provided. The method includes: providing 3 to 20 conductive wires, and obtaining a first-level wire core after first twisting; providing a plurality of first-level wire cores, and obtaining a second-level wire core after second twisting of the plurality of first-level wire cores; and providing a plurality of second-level wire cores, and forming a wire material of the induction coil after third twisting of the plurality of second-level wire cores.

In a more preferred implementation, obtaining a third-level wire core after the third twisting of the plurality of second-level wire cores; and providing a plurality of third-level wire cores, and forming a wire material of the induction coil after fourth twisting of the plurality of third-level wire cores.

The induction coil is conducive to suppressing self-formed current deviation and reducing an internal loss of the induction coil. In addition, the induction coil of an aerosol generation apparatus can avoid wire breakage, reduce alternating current impedance of the induction coil, and reduce a loss caused by an internal proximity effect, to improve heating efficiency of an aerosol generation apparatus.

### BRIEF DESCRIPTION OF THE DRAWINGS

One or more embodiments are exemplarily described with reference to corresponding figures in the accompanying drawings, and the exemplary descriptions are not to be construed as limiting the embodiments. Elements/modules and steps in the accompanying drawings that have same reference numerals are represented as similar elements/modules and steps, and unless otherwise particularly stated, the figures in the accompanying drawings are not drawn to scale.

FIG. 1 is a schematic structural diagram of an aerosol generation apparatus according to Embodiment 1 in detailed description of this application;

FIG. 2 is a schematic structural diagram of an induction coil in FIG. 1 from a perspective;

FIG. 3 is a schematic cross-sectional view of a wire material of the induction coil in FIG. 2;

FIG. 4 is a schematic cross-sectional view of a wire material of an induction coil of another implementation example according to Embodiment 1 in detailed description of this application;

FIG. 5 is a schematic cross-sectional view of an induction coil of another implementation example according to Embodiment 1 in detailed description of this application;

FIG. 6 is a schematic cross-sectional view of a wire material of the induction coil in FIG. 5;

FIG. 7 is a schematic structural diagram of an induction coil of another implementation example according to Embodiment 1 in detailed description of this application;

FIG. 8 is a schematic structural diagram of an induction coil of another implementation example according to Embodiment 1 in detailed description of this application;

FIG. 9 is a schematic structural diagram of an aerosol generation apparatus of another implementation example according to Embodiment 1 in detailed description of this application;

FIG. 10 is temperature change curves of an induction coil according to Embodiment 1 and an induction coil in a comparative embodiment during use in detailed description of this application;

FIG. 11 is a schematic structural diagram of an aerosol generation apparatus according to Embodiment 2 in detailed description of this application;

FIG. 12 is a schematic diagram of an induction coil according to Embodiment 2 in detailed description of this application;

FIG. 13 is a schematic cross-sectional view of a wire material of an induction coil according to Embodiment 2 in detailed description of this application;

FIG. 14 is a schematic cross-sectional view of another wire material of an induction coil according to Embodiment 2 in detailed description of this application;

FIG. 15 is a schematic diagram of another induction coil according to Embodiment 2 in detailed description of this application; and

FIG. 16 is a schematic diagram of a method for forming an induction coil according to Embodiment 2 in detailed description of this application.

### DETAILED DESCRIPTION

For ease of understanding of this application, this application is described in further detail below with reference to the accompanying drawings and specific implementations. Unless otherwise defined, meanings of all technical and scientific terms used in this specification are the same as that usually understood by a person skilled in the art to which this application belongs. The terms used in this specification of this application are merely intended to describe objectives of the specific implementations, and are not intended to limit this application. The term “and/or” used in this specification includes any or all combinations of one or more related listed items.

An aerosol-generation device provided in this application is used for heating an aerosol generation substrate, to generate an aerosol for inhalation. The aerosol generation substrate may be a solid substrate, or may be liquid substrate. A carrier that carries the aerosol generation substrate may be a rod-shaped or stick-shaped aerosol generation article. The aerosol generation article includes at least one volatile solid substrate. The carrier may alternatively be a cartridge accommodating a specific capacity of the liquid substrate. The cartridge has a liquid storage cavity or a holding medium for storing the liquid substrate inside. For ease of understanding of this application, this application is described in further detail below with reference to the accompanying drawings and specific implementations.

### Embodiment 1

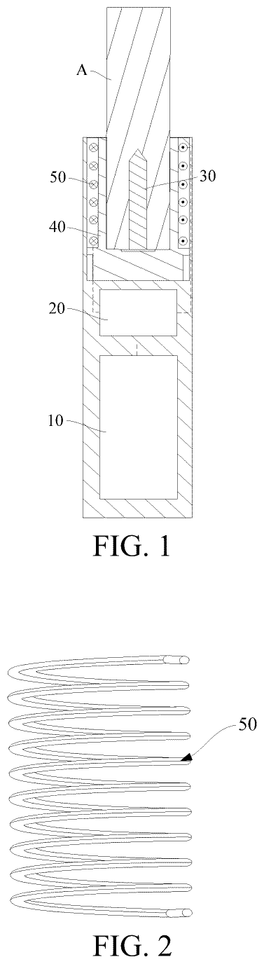

An embodiment of this application provides an aerosol generation apparatus, whose construction may refer to FIG. 1, including:
a chamber, where an aerosol generation substrate A is removable received in the chamber;
an induction coil 50, configured to generate a changing magnetic field in an alternating current;
a susceptor 30, at least partially extending in the chamber, and configured to be inductively coupled to the induction coil 50, and be penetrated by the changing magnetic field to produce heat, to heat the aerosol generation substrate A, for example, a cigarette, so that at least one component of the aerosol generation substrate A is evaporated, to form an aerosol for inhalation;
a battery cell 10, being a rechargeable direct current battery cell, and capable of outputting a direct current; and
a circuit 20, electrically connected to the rechargeable battery cell 10 properly, and configured to convert the direct current outputted by the battery cell 10 into an alternating current with a suitable frequency and supply the alternating current to the induction coil 50.

According to the settings in use of a product, the induction coil 50 may include a cylindrical inductor coil wound into a spiral shape, as shown in FIG. 1. The cylindrical induction coil 50 wound into the spiral shape may have a radius r ranging from about 5 mm to about 10 mm, and the radius r may be about 7 mm in particular. The cylindrical induction coil 50 wound into the spiral shape may have a length ranging from about 8 mm to about 14 mm, and a number of turns of the induction coil 50 may range from 8 to 15. Correspondingly, an inner volume may range from about 0.15 cm³ to about 1.10 cm³.

In a more preferred implementation, the frequency of the alternating current supplied by the circuit 20 to the induction coil 50 ranges from 80 KHz to 500 KHz. More specifically, the frequency may be in a range of approximately 200 KHz to 300 KHz.

In a preferred embodiment, a direct-current voltage provided by the battery cell 10 ranges from about 2.5 V to about 9.0 V, and the direct current provided by the battery cell 10 ranges from about 2.5 A to about 20 A.

In a preferred embodiment, the susceptor 30 is substantially in a shape of a pin, a needle, a stick, or a blade, which is conducive to inserting into the aerosol generation substrate A. In addition, the susceptor 30 may have a length of about 12 mm, a width of about 4 mm, and a thickness of about 0.5 mm, and may be made of stainless steel of level 430 (SS430). In an alternative embodiment, the susceptor 30 may have a length of about 12 mm, a width of about 5 mm, and a thickness of about 0.5 mm, and may be made of stainless steel of level 430 (SS430). In other variant embodiments, the susceptor 30 may be constructed as a cylindrical shape or a tube shape. During use, an internal space of the susceptor forms the chamber configured to receive the aerosol generation substrate A, and generates the aerosol for inhalation by heating an outer periphery of the aerosol generation substrate A. These susceptors 30 may alternatively be made of stainless steel of level 420 (SS420) and alloy materials containing iron/nickel (such as permalloy).

In an embodiment shown in FIG. 1, the aerosol generation apparatus further includes a bracket 40 configured to arrange the induction coil 50 and the susceptor 30, and a material of the bracket 40 may include a non-metal material with high temperature resistance such as PEEK or ceramic. During implementation, the induction coil 50 winds around an outer wall of the bracket 40 to be fixed. In addition, as shown in FIG. 1, the bracket 40 is of a hollow tubular shape. A part of space of a tubular hollow part of the bracket 40 forms the chamber configured to receive the aerosol generation substrate A.

In an optional implementation, the susceptor 30 is made of a susceptive material, or is obtained by forming a susceptive material coating through electroplating, deposition, or the like on an outer surface of the substrate material with high-temperature resistance, such as ceramic.

Further, FIG. 2 is a schematic structural diagram of an induction coil 50 according to an embodiment. The induction coil 50 is a solenoid coil made by winding an elongated wire material; and is arranged around the chamber and/or the susceptor 30 after assembly. In this embodiment, a cross-sectional outline of the wire material of the induction coil 50 is circular.

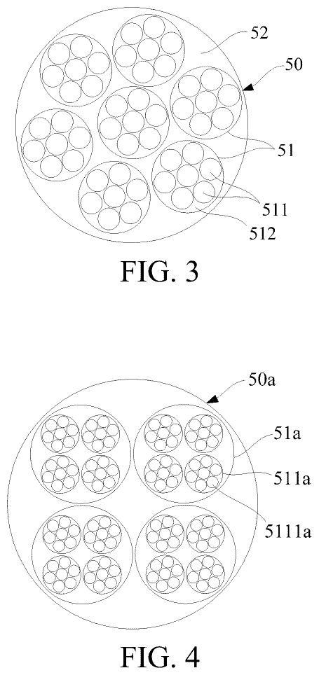

Further, FIG. 3 is a schematic cross-sectional view of an embodiment of a wire material of the induction coil 50 in FIG. 2. During implementation, the wire material of the induction coil 50 includes at least two wire cores 51, and each wire core 51 includes at least two conductive wires 511. In a more preferred implementation, it is suitable that the wire material of the induction coil 50 includes 3 to 10 wire cores 51. It is suitable that each wire cores 51 includes about 10 to 50 conductive wires 511.

Corresponding to the above during implementation in which the induction coil 50 generates the changing magnetic field at a frequency ranging from 80 KHz to 500 KHz, it is suitable that a maximum diameter of each conductive wire 511 is less than or equal to one third of a skin depth. Based on the implementations, the skin depth approximately ranges from 0.12 mm to 0.25 mm when the above frequency is used during work. Therefore, in an ideal case, it is ideal that the maximum diameter of each conductive wire 511 approximately ranges from 0.02 mm to 0.07 mm.

In some implementations, the conductive wire 511 is prepared by using low-resistivity metals or alloys such as copper, gold, silver, or alloys thereof, and carbon materials (carbon fiber or other conductive carbon materials). During implementation, based on meeting the above requirement of the skin depth, the conductive wire 511 also needs to be prepared conveniently in intensity and production. In a preferred implementation, it is suitable that each conductive wire 511 has the diameter approximately ranging from 0.05 mm to 0.2 mm.

Specifically, the conductive wire 511 is made of a copper wire of the above diameter, and approximately has an elongation at break ranging from 1% to 6%. This is conducive to convenience in production and preparation as well as intensity. In addition, the conductive wires 511 are distributed substantially uniformly in the wire core 51.

Further, in a more preferred implementation, the induction coil 50 may include 12 to 200 conductive wires 511 in total. In a specific implementation, the induction coil 50 has 5 wire cores 51. Each wire core 51 includes 24 conductive wires 511. The diameter of each conductive wire 511 is 0.08 mm. The conductive wire 511 is a copper wire.

The induction coil 50 constructed by using the plurality of wire cores 51 is helpful to eliminate an “internal proximity effect” (that is, an alternating magnetic field generated by a single conductive wire generate an eddy current in other adjacent conductive wires) of an induction coil 50 prepared by using a single conductive wire during work, which is conducive to suppressing a current deviation of the induction coil 50; and further reduces internal resistance and an internal loss of the induction coil 50.

Further, in a more preferred implementation, an insulating material layer, such as insulating paint or an insulating film, is formed on a surface of each conductive wire 511 in the wire core 51 by deposition, spraying, or the like, so that each conductive wire 511 in the wire core 51 is insulated from each other. In an optional implementation, an insulating material includes, but is not limited to, Teflon, polytetrafluoroethylene, polyimide, aromatic amide polymer, and the like.

In some implementations, the wire core 51 is formed by twisting a plurality of conductive wires 511. In a more preferred implementation, the plurality of conductive wires 511 are twisted in a clockwise or counterclockwise direction.

In some other implementations, the conductive wires 511 in each wire core 51 are in parallel in a spiral manner, or wound or braided together, so that the conductive wires are stably wound without unraveling.

Each wire core 51 further includes a first cladding layer 512, configured to cover the twisted conductive wires 511, to prevent or stop the conductive wires 511 in the wire core 51 from unraveling. In a preferred implementation, the first cladding layer 512 is prepared and formed by using a silk covered wire (such as cellulose acetate filaments or polyester fiber filaments) commonly used in cable manufacturing.

In a preferred implementation, the wire core 51 with the twisted conductive wires 511 and covered by the first cladding layer 512 has an outer diameter approximately ranging from 0.25 mm to 1 mm.

In a more preferred implementation, after the twisting, the wire core 51 prepared with silk covered has an ultimate tensile strength of more than 50 MPa.

Alternatively, in some other variant implementations, the wire core 51 has an approximately rectangular cross-sectional area.

Alternatively, in some other variant implementations, the conductive wire 511 is a sheet wire with a rectangular cross section, for example, an elongated strip sheet wire obtained by cutting a copper foil.

In a specific implementation, the first cladding layer 512 in each wire core 51 are formed by bonding materials such as cellulose acetate filaments or polyester fiber filaments outside the twisted conductive wires 511 through a hot air self-adhesive or an acetone self-adhesive process, and after curing, the first cladding layer 512 is formed. The hot air self-adhesive process is to heat a mold with hot air when winding the cellulose acetate filaments or polyester fiber filaments around the twisted conductive wires 511, so that a mold temperature reaches a bonding temperature of the filaments, to cause the cellulose acetate filaments or polyester fiber filaments to be bonded and molded outside the conductive wires 511 to form the first cladding layer 512. The acetone self-adhesive process is to coat or spray acetone on a surface of the filaments when winding the cellulose acetate filaments around the twisted conductive wires 511, to bond the cellulose acetate filaments together by using the acetone, and after curing, the first cladding layer 512 is formed.

Alternatively, in another variant implementation, the first cladding layer 512 in the wire core 51 is obtained by coating on a surface after internal filling in a similar optical fiber/cable preparation method. Specifically, in some implementations, fillers such as polyethylene, polyvinyl chloride (PVC), or nylon are used to fill gaps between the conductive wires 511 in a twisting process, and then coating materials such as phenolic resin, alkyd resin, acrylonitrile-butadiene rubber, or ethylene propylene diene monomer are used for coating to obtain the first cladding layer. This is conducive to prevent the conductive wires 511 in the wire core 51 from unraveling and slipping off after preparation.

Further, the wire material of the induction coil 50 is formed by twisting a plurality of wire cores 51; or the wire material of the induction coil 50 is formed by arranging the plurality of wire cores 51 in parallel or winding or twisting the plurality of wire cores 51.

Further, during implementation, the induction coil 50 further includes a second cladding layer 52, configured to cover the twisted plurality of wire cores 51, to prevent or stop the plurality of wire cores 51 from unraveling. Similarly, the second cladding layer 52 is also prepared by using materials and processes similar to those of the first cladding layer 512.

In a more preferred implementation, further, a cross section of the induction coil 50 with twisted plurality of wire cores 51 and covered by the second cladding layer 52 has an outer diameter approximately ranging from 1 mm to 3 mm.

Similarly, the first cladding layer 512 and the second cladding layer 52 are substantially insulating materials. After preparation, the wire cores 51 are insulated from each other.

Further, FIG. 4 is a schematic cross-sectional view of a wire material of an induction coil 50a according to another embodiment. The induction coil 50a in this embodiment includes:
at least two wires 51a. Each wire 51a includes at least two wire cores 511a. Each wire core 511a includes a plurality of conductive wires 5111a.

In a preferred implementation, the wire material of the induction coil 50a in the embodiment shown in FIG. 4 is obtained by further twisting or winding the wire material in the embodiment shown in FIG. 3 again.

Alternatively, in other variant implementations, a plurality of wire material of the induction coil 50a in the embodiment shown in FIG. 4 may further be twisted or wound to obtain a better induction coil.

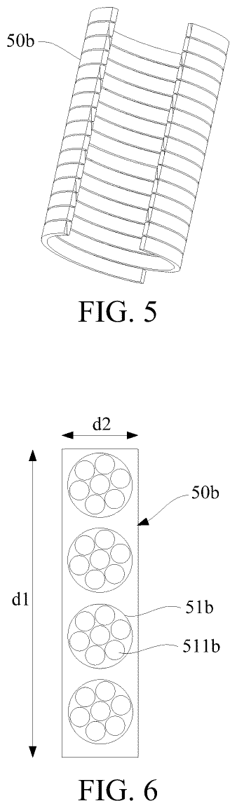

Further, FIG. 5 is a schematic structural diagram of an induction coil 50b according to an embodiment. The induction coil 50b in this embodiment is in a form of a solenoid coil; and a cross section of a wire material of the induction coil 50b is in a wide or flat shape that is different to a conventional circle.

Further, FIG. 6 is a schematic diagram of a cross section of a wire material of the induction coil 50b in FIG. 5. The cross section of the wire material of the induction coil 50b has a first dimension d1 extending in a longitudinal direction, and a second dimension d2 extending in a radial direction perpendicular to the longitudinal direction. The first dimension d1 of the cross section of the wire material of the induction coil 50b extending in the longitudinal direction is greater than the second dimension d2 extending in the radial direction, so that the cross section of the wire material of the induction coil 50b is substantially in a flat rectangular shape. In a preferred implementation, the first dimension d1 is approximately 1˜mm. The second dimension d2 is approximately 0.1˜0.5 mm. In some embodiments, maximum dimensions of the cross section of the wire material of the induction coil 50b formed on the above two directions are different, for example, an ellipse.

In short, in the induction coil 50b whose wire material has a flat-shaped cross section, the form of the wire material is completely or at least flattened. Therefore, the wire material extends in the radial direction to a small degree. Through such measures, an energy loss in the induction coil 50b can be reduced. In addition, the induction coil 50b can be thinner in the radial direction, which is conducive to reducing a skin effect.

Further, referring to FIG. 6, the wire material of the induction coil 50b includes at least two wire cores 51b, and each wire core 51b includes a plurality of twisted or wound conductive wires 511b. In a more preferred implementation, the wire core 51b is arranged or distributed in the longitudinal direction of the cross section of the wire material.

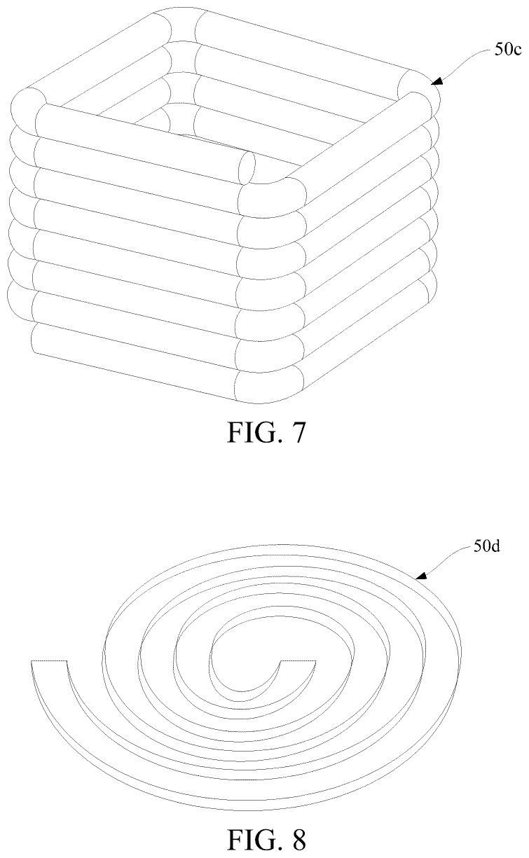

Alternatively, in an implementation shown in FIG. 7, an induction coil 50c is constructed into a solenoid shape with a square cross section.

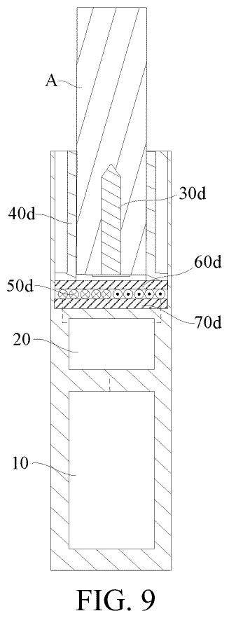

FIG. 8 and FIG. 9 are schematic diagrams of an induction coil 50d and an aerosol generation apparatus having an induction coil 50d according to another variant embodiment. In this embodiment, the induction coil 50d is constructed into a planar spiral coil.

In some implementations, a cross section of a wire material of the induction coil 50d is a common circle. Alternatively, in some other variant implementations, the cross section of the wire material of the induction coil 50d is a flat shape or a rectangle. Specifically, for example, an extension dimension of the wire material of the induction coil 50d in a radial direction is greater than an extension dimension in an axial direction, so that the cross section is substantially rectangular.

In addition, the wire material of the induction coil 50d may be formed by twisting or winding at least two wire bundles. Similarly, each wire bundle includes at least two twisted or wound conductive wires.

Further, as shown in FIG. 9, the aerosol generation apparatus in this embodiment includes:
a bracket 40d, defining a chamber configured to receive an aerosol generation substrate A;
a susceptor 30d, at least partially located in the chamber, and penetrated by a changing magnetic field to produce heat, to heat the aerosol generation substrate A received in the chamber; and
a planar induction coil 50d, substantially arranged in a longitudinal direction perpendicular to the aerosol generation apparatus, and configured to generate the changing magnetic field.

In a more preferred implementation, the planar induction coil 50d is located between the susceptor 30d/bracket 40d and a circuit 20.

In a more preferred implementation, the planar induction coil 50d and the susceptor 30d are arranged coaxially. Alternatively, a central axis of the susceptor 30d substantially overlaps a central axis of the planar induction coil 50d.

In a preferred implementation, the planar induction coil 50d is supported and fixed by a first support member 60d and a second support member 70d.

In some implementations, the first support member 60d and/or the second support member 70d are sheet-like or plate-like in parallel with the planar induction coil 50d.

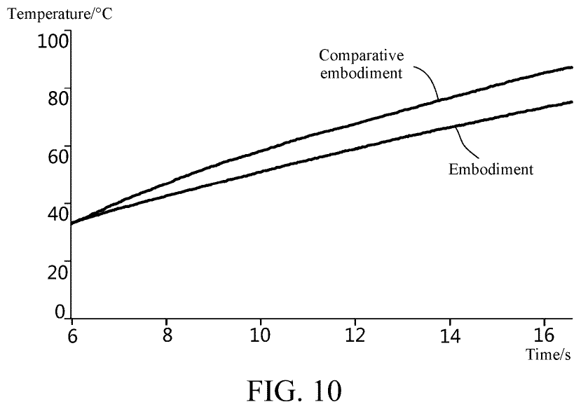

Further, FIG. 10 shows a temperature change curve of the induction coil 50 measured when an alternating current with an amplitude of 6 A and a frequency ranging from 200 KHz to 300 KHz is supplied to the induction coil 50 of the wire material with the structure shown in FIG. 3. In an embodiment of this test, the induction coil 50 is obtained by dividing 120 copper wires with a diameter of 0.08 mm into 5 bundles, and respectively twisting each bundle, which includes 24 copper wires, in sequence.

Similarly, FIG. 10 shows a temperature change curve of an induction coil measured when an alternating current with an amplitude of 6 A and a frequency ranging from 200 KHz to 300 KHz is supplied in a comparative embodiment. In this comparative embodiment, the induction coil is prepared by using a wire material that twists all 120 copper wires with a diameter of 0.08 mm into 1 bundle.

According to test results in FIG. 10, a temperature of heat produced by the induction coil in the comparative embodiment is always higher than that of the induction coil 50 in the embodiment. In a case that a material and a number of copper wire are both the same, and the alternating currents provided by power supply are the same, the higher temperature of the induction coil in the comparative embodiment than that in the embodiment is less likely caused by the material or internal resistance, but more likely caused by an internal proximity effect. In contrast, the induction coil in the embodiment is conducive to suppressing self-formed current deviation and reducing the internal loss of the induction coil.

### Embodiment 2

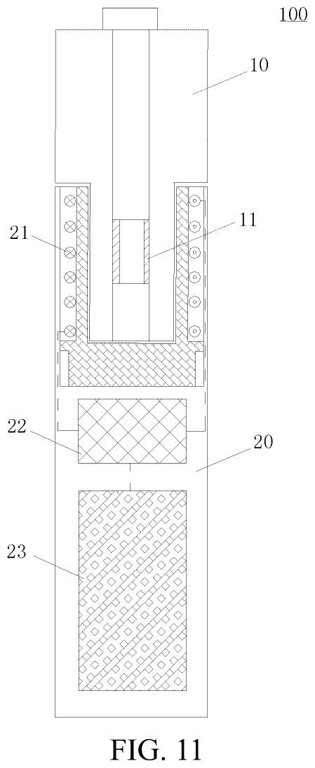

FIG. 11 is a schematic diagram of an aerosol generation apparatus according to an implementation of this application.

As shown in FIG. 11, an aerosol generation apparatus 100 includes an atomizer 10 and a power supply component 20. The atomizer 10 is removably connected to the power supply component 20. Connection between the atomizer 10 and the power supply component 20 may be buckled connection, magnetic connection, or the like.

The atomizer 10 includes a susceptor 11 and a liquid storage cavity (not shown). The liquid storage cavity is configured to store an atomizable liquid substrate. The susceptor 11 is configured to be inductively coupled to the induction coil 21, and be penetrated by a changing magnetic field to produce heat, to heat the liquid substrate, to generate an aerosol for inhalation.

The liquid substrate, preferably, includes a tobacco-containing material. The tobacco-containing material includes a volatile tobacco aroma compound that is released from the liquid substrate when heated. Alternatively, or in addition, the liquid substrate may include a non-tobacco material. The liquid substrate may include water, ethanol or other solvents, plant extracts, nicotine solutions, and natural or artificial flavorings. Preferably, the liquid substrate further includes an aerosol-forming agent. An instance of a proper aerosol-forming agent is glycerine and propylene glycol.

Generally, the susceptor 11 may be made of at least one of the following materials: aluminum, iron, nickel, copper, bronze, cobalt, plain carbon steel, stainless steel, ferritic stainless steel, martensitic stainless steel or austenitic stainless steel.

In some exemplary implementations, the susceptor 11 may be in direct or indirect contact with the liquid substrate, to release heat to evaporate the liquid substrate. Further, the atomizer 10 further includes a liquid transmission unit, and the susceptor 11 is in indirect contact with the liquid substrate through the liquid transmission unit. The liquid transmission unit may be cotton fiber, metal fiber, ceramic fiber, glass fiber, porous ceramic, or the like, and can transmit the liquid substrate stored in the liquid storage cavity to the susceptor 11 through capillary action. In some optional implementations, the susceptor 11 may remain non-contact with the liquid substrate, and heat the liquid substrate by radiating heat.

In some exemplary implementations, the susceptor 11 is constructed into a tube with a closed ring or a non-closed ring, and the susceptor 11 is wound by a sheet-like metal mesh and supported on an inner surface of the liquid transmission unit.

In some exemplary implementations, the susceptor 11 may further include a radial portion extending from an end of the tube in a radial direction. The radial portion may fit an end portion of the liquid transmission unit.

In some exemplary implementations, the susceptor 11 is buried in the liquid transmission unit, and co-sintered with the liquid transmission unit to form an atomization core. In this way, the liquid substrate does not need to be atomized until the liquid substrate is transmitted to and in contact with the surface of the susceptor 11, but starts to be heated and atomized when being close to the susceptor 11. There is thermally conductive contact between the susceptor 11 and the liquid transmission unit, preventing dry burning, and most liquid substrates are not in direct contact with the susceptor 11 when atomized, avoiding metal pollution generated by the susceptor 11.

In some exemplary implementation, the susceptor 11 may include a plurality of closed rings spaced apart. Each closed ring includes the same or different metal materials. For example, Curie temperature points of different materials of the closed ring are different.

In some exemplary implementations, the susceptor 11 may be of a plate-shaped structure. The susceptor 11 of the plate-shaped structure may have a plurality of mesh pores.

In some exemplary implementations, a weight of the susceptor 11 ranges from 10 mg to 30 mg. Preferably, the weight ranges from 10 mg to 25 mg; further, preferably, the weight ranges from 10 mg to 23 mg; further, preferably, the weight ranges from 15 mg to 23 mg; and further, preferably, the weight ranges from 18 mg to 23 mg. In a specific example, the weight of the susceptor 11 may be 20 mg, 21 mg, or the like.

The power supply component 20 includes the induction coil 21, a circuit 22, and a battery cell 23.

The induction coil 21 is configured to generate a changing magnetic field in an alternating current.

The circuit 22 may control an entire operation of the aerosol generation apparatus 100. The circuit 22 does not only control operations of the battery cell 23 and the induction coil 21, but also controls operations of other components in the aerosol generation apparatus 100.

In an example, a frequency of an alternating current supplied by the circuit 22 to the induction coil 21 ranges from 500 KHz to 3 MHz; preferably, the frequency may range from 500 KHz to 2.5 MHz; further, preferably, the frequency may range from 500 KHz to 2 MHz; further, preferably, the frequency may range from 500 KHz to 1.5 MHz; and further, preferably, the frequency may range from 500 KHz to 1 MHz. For example, the frequency of the alternating current supplied by the circuit 22 to the induction coil 21 is 500 KHz, or 600 KHz, or 800 KHz, or 1.2 MHz.

The battery cell 23 provides power for operating the aerosol generation apparatus 100. The battery cell 23 may be a rechargeable battery cell or a disposable battery cell.

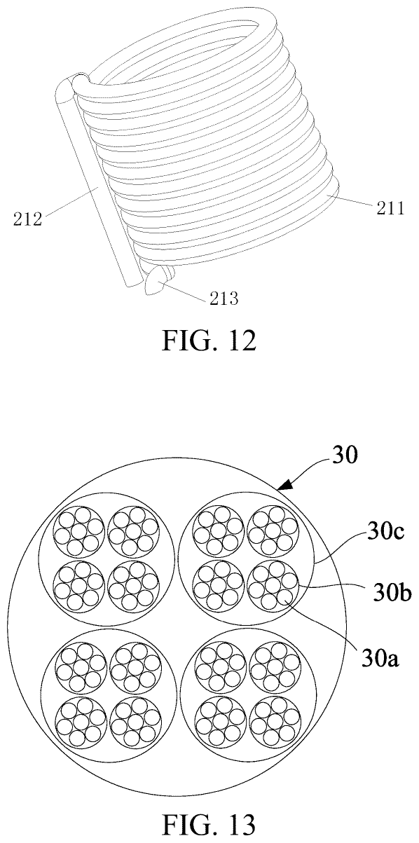

FIG. 12 is a schematic diagram of an induction coil according to an implementation of this application.

As shown in FIG. 12, the induction coil 21 includes a main body 211, an electrical connection portion 212, an electrical connection portion 213. The electrical connection portion 212 and the electrical connection portion 213 are configured to be electrically connected to the battery cell 23.

After assembly, the main body 211 is arranged around the susceptor 11. The main body 211 may be sleeved on a bracket (not shown), and a shape of the bracket is similar to that of the main body 211.

The main body 211 is a solenoid coil made by winding an elongated wire material, for example: 500 to 2,000 wires are used for winding and forming, or 500 to 1,900 wires are used, or 700 to 1,900 wires are used, or 900 to 1,900 wires are used, or 1,000 to 1,900 wires are used, or 1,200 to 1,900 wires are used, or 1,400 to 1,900 wires are used, or 1,600 to 1,900 wires are used.

A cross section of the wire material may be rectangular, circular, or elliptical. Preferably, the cross section is rectangular, so that the wire material of the induction coil 21 is of a flat structure. This is conducive to increasing a number of turns of the induction coil 21 per unit length to improve an inductance value.

A total length of the main body 211 in an axial direction approximately ranges from 5 mm to 20 mm. In a specific embodiment, a total length of the induction coil 21 in the axial direction is 12.2 mm.

A cross section of a hollow part of the main body 211 is non-circular, for example, elliptical; and a cross section of the main body 211 is runway-shaped. In some examples, a difference between a long axis and a short axis of the ellipse ranges from 0.5 mm to 2 mm. Specifically, a length of the long axis of the ellipse ranges from 8 mm to 15 mm (preferably, ranges from 8 mm to 12 mm; further, preferably, ranges from 8 mm to 10 mm; and further, preferably, ranges from 9 mm to 10 mm); and a length of the short axis of the ellipse ranges from 8 mm to 13 mm (preferably, ranges from 8 mm to 11 mm; further, preferably, ranges from 8 mm to 10 mm and further, preferably, ranges from 8 mm to 9 mm). In a specific embodiment, the length of the long axis is 9.7 mm, and the length of the short axis is 8.9 mm. The main body 211 with such a shape facilitates production of the induction coil 21 and assembling the induction coil 21 into the power supply component 20.

The number of turns or windings of the solenoid ranges from 4 to 20; preferably, ranges from 6 to 20; further, preferably, ranges from 6 to 15; further, preferably, ranges from 6 to 12; and further, preferably, ranges from 6 to 10. The induction coil 21 with such the number of turns can provide an effective magnetic field for heating the susceptor 11.

Spacings between adjacent windings may be the same, or may be different. The spacing between adjacent windings approximately ranges from 0.1 mm to 2 mm; or ranges from 0.1 mm to 1.5 mm; or ranges from 0.1 mm to 1 mm; or ranges from 0.1 mm to 0.5 mm. In a specific embodiment, the spacing between adjacent windings is 0.2 mm or 0.4 mm. It is found that these specific spacings provide effective heating of the susceptor 11, thereby providing effective heating to the liquid substrate.

FIG. 13 is a schematic cross-sectional view of a wire material of an induction coil according to an implementation of this application.

It should be noted that, a wire strand 30b and a wire strand 30c described in this embodiment are a type of the wire core in Embodiment 1, and a wire 30a described in this embodiment is the conductive wire in Embodiment 1, which are different names of the same objects.

As shown in FIG. 13, the wire material 30 of the induction coil 21 includes a plurality of wire strands 30c, and each wire strand 30c includes a plurality of wire strands 30b. Each wire strand 30b has 3 to 20 wires 30a inside; or has 3 to 18 wires 30a; or has 3 to 16 wires 30a; or has 3 to 14 wires 30a; or has 3 to 12 wires 30a; or has 5 to 12 wires 30a; or has 8 to 12 wires 30a. In a specific embodiment, each wire strand 30b may have 10 wires 30a.

In an embodiment, the wire 30a is prepared by using low-resistivity metals or alloys such as copper, gold, silver, or alloys thereof, and carbon materials (carbon fiber or other conductive carbon materials).

In an embodiment, a cross section of the wire 30a may be circular or rectangular. In a preferred implementation, the cross section of the wire 30a is circular, which can avoid wire breakage, and is conducive to reducing alternating current impedance of the induction coil.

Under same conditions such as a working frequency, a number of twisting times, a number of the wires 30a (corresponding to “Number of wires” in the following table) in first twisting, an impedance analyzer may be used to measure a real part of equivalent impedance (corresponding to “Equivalent impedance 1” in the following table) of the induction coil 21 when the cross section of the wire 30a is circular, and a real part of equivalent impedance (corresponding to “Equivalent impedance 2” in the following table) of the induction coil 21 when the cross section of the wire 30a is rectangular for verification. In this measuring process, for the number of twisting times, twice twisting is used, and the number of wires 30a in the first twisting is 45. Measurement results are as follows:

| Serial | Working | | Number of | Number of | Equivalent | Equivalent |
|---|---|---|---|---|---|---|
| number | frequency | | twisting times | wires | impedance 1 | impedance 2 |
| 1 | 500 | KHz | Twice | 45 | 22.56 mΩ | 24.68 mΩ |
| 2 | 1 | MHz | Twice | 45 | 30.46 mΩ | 32.56 mΩ |
| 3 | 1.5 | MHz | Twice | 45 | 38.44 mΩ | 39.96 mΩ |
| 4 | 2 | MHz | Twice | 45 | 46.86 mΩ | 48.46 mΩ |
| 5 | 2.5 | MHz | Twice | 45 | 55.47 mΩ | 57.89 mΩ |
| 6 | 3 | MHz | Twice | 45 | 66.89 mΩ | 68.38 mΩ |

It can be learned from the measurement results that under the same conditions, a value of the equivalent impedance 1 is less than a value of the equivalent impedance 2. That is, the real part of the equivalent impedance of the induction coil 21 when the cross section of the wire 30a is circular is less than the real part of the equivalent impedance of the induction coil 21 when the cross section of the wire 30a is rectangular, even at a high working frequency. Therefore, when the cross section of the wire 30a is circular, it is conducive to reduce the alternating current impedance of the induction coil.

In an embodiment, corresponding to the above during implementation in which the induction coil 21 generates the changing magnetic field at a frequency ranging from 500 KHz to 3 MHz, it is ideal that a diameter of the wire 30a ranges from 0.01 mm to 0.05 mm. In a specific embodiment, the diameter of the wire 30a may be 0.03 mm or 0.04 mm. A small diameter of the wire 30a facilitates reducing an impact of a skin effect of the induction coil 21, and improving heating efficiency of the susceptor, which is conducive to improving an atomization speed of the liquid substrate. In addition, use of an induction coil with a small wire diameter is conducive to reducing a size and mass of the susceptor, and reducing a volume of the atomizer used in cooperation with the power supply component.

In an embodiment, each wire strand 30b in the plurality of wire strands 30b may have a same number of wires, or may have different numbers of wires. For example, a wire strand 30b has 10 wires 30a, and another wire strand 30b has 15 wires 30a.

In an embodiment, 3 to 20 wires 30a are twisted for the first time to obtain a wire strand 30b, then a plurality of wire strands 30b are twisted for the second time to obtain a wire strand 30c, and eventually, a plurality of wire strands 30c are twisted for the third time to form the wire material 30 of the induction coil 21.

A number of wire strands 30b and a number of wire strands 30c are not limited, and are generally determined based on a total number of wires 30a in the induction coil 21. For example, if the main body 211 is formed by winding 1,600 wires, 10 wires 30a may be first twisted for the first time to obtain a wire strand 30b, then 16 wire strands 30b are twisted for the second time to obtain a wire strand 30c, and eventually, 10 wire strands 30c are twisted for the third time to obtain the main body 211.

In the above twisting process, the wires may be twisted in a clockwise or counterclockwise direction.

The induction coil 21 formed in such a way can avoid wire breakage, reduce alternating current impedance of the induction coil, and reduce a loss caused by an internal proximity effect, to improve heating efficiency of an aerosol generation apparatus.

In a further implementation, an insulating material layer, such as insulating paint or an insulating film, may be formed on a surface of each wire 30a in the wire strand 30b by deposition, spraying, or the like, so that each wire 30a in the wire strand 30b is insulated from each other. In an optional implementation, an insulating material includes, but is not limited to, Teflon, polytetrafluoroethylene, polyimide, aromatic amide polymer, and the like.

Each wire strand 30b further includes a cladding layer (not shown) configured to cover the twisted wires 30a, to prevent or stop the wires 30a in the wire strand 30b from unraveling. In a preferred implementation, the cladding layer is prepared and formed by using a silk covered wire (such as cellulose acetate filaments or polyester fiber filaments) commonly used in cable manufacturing.

In a specific implementation, the cladding layer in each wire strand 30b are formed by bonding materials such as cellulose acetate filaments or polyester fiber filaments outside the twisted wires 30a through a hot air self-adhesive or an acetone self-adhesive process, and after curing, the cladding layer is formed. The hot air self-adhesive process is to heat a mold with hot air when winding the cellulose acetate filaments or polyester fiber filaments around the twisted wires 30a, so that a mold temperature reaches a bonding temperature of the filaments, to cause the cellulose acetate filaments or polyester fiber filaments to be bonded and molded outside the wires 30a to form the cladding layer. The acetone self-adhesive process is to coat or spray acetone on a surface of the filaments when winding the cellulose acetate filaments around the twisted wires 30a, to bond the cellulose acetate filaments together by using the acetone, and after curing, the cladding layer is formed.

Alternatively, in another variant implementation, the cladding layer in the wire strand 30b is obtained by coating on a surface after internal filling in a similar optical fiber/cable preparation method. Specifically, in some implementations, fillers such as polyethylene, polyvinyl chloride (PVC), or nylon are used to fill gaps between the wires 30a in a twisting process, and then coating materials such as phenolic resin, alkyd resin, acrylonitrile-butadiene rubber, or ethylene propylene diene monomer are used for coating to obtain the cladding layer. This is conducive to prevent the wires 30a in the wire strand 30b from unraveling and slipping off after preparation.

Further, during implementation, similarly, a similar foregoing cladding layer is used, and the plurality of wire strands 30b or the plurality of wire strands 30c are insulated from each other.

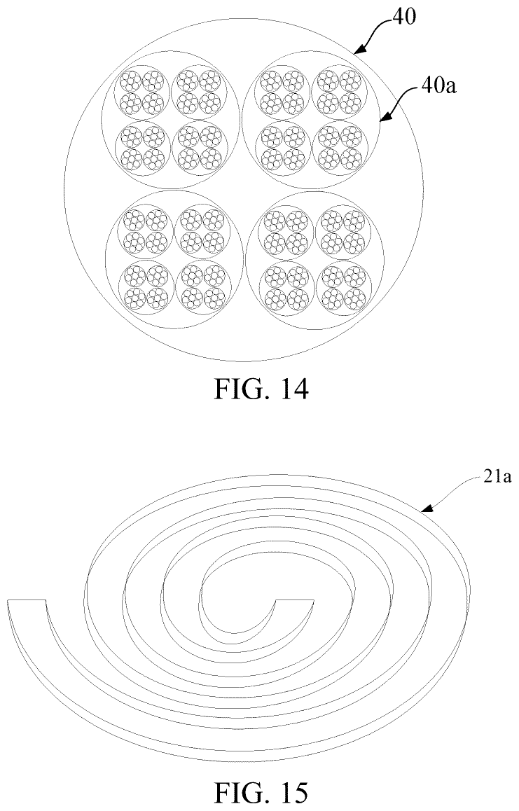

FIG. 14 is a schematic cross-sectional view of another wire material of an induction coil according to an implementation of this application.

Different from FIG. 13, a wire material 40 shown in FIG. 14 includes a plurality of wire strands 40a, and the plurality of wire strands 40a are twisted for the fourth time to obtain the wire material 40 of the induction coil 21. Each wire strand 40a is similar to the wire material 30 shown in FIG. 13, that is, formed through three times of twisting.

The wire material 40 formed through four times of twisting can further avoid the wire breakage, and reduce the alternating current impedance of the induction coil. It is found that all the wire materials formed after at least three times of twisting can achieve the foregoing objective. In view of cost of twisting process, preferably, the twisting process is used three or fourth times for obtaining the wire material.

To further verify an impact of the number of twisting times and the number of wires 30a in the first twisting, the inventor selects two different sets of measurement conditions to measure the real part of the equivalent impedance. One set of measurement conditions is that the number of twisting times is two, and the number of wires 30a in the first twisting is 45 (corresponding to “Equivalent impedance 3” in the following table); and the other set of measurement conditions is that the number of twisting times is four, and the number of wires 30a in the first twisting is 10 (corresponding to “Equivalent impedance 4” in the following table). Other measurement conditions are the same, for example, the working frequency ranges from 500 KHz to 3 MHz, and all the cross sections of the wires 30a are circular. The impedance analyzer is used for measurement, and measurement results are as follows:

| Serial | Working | | Cross-section | Equivalent | Equivalent |
|---|---|---|---|---|---|
| number | frequency | | shape of wires | impedance 3 | impedance 4 |
| 1 | 500 | KHz | Circular | 22.56 mΩ | 14.09 mΩ |
| 2 | 1 | MHz | Circular | 30.46 mΩ | 16.15 mΩ |
| 3 | 1.5 | MHz | Circular | 38.44 mΩ | 18.33 mΩ |
| 4 | 2 | MHz | Circular | 46.86 mΩ | 20.83 mΩ |
| 5 | 2.5 | MHz | Circular | 55.47 mΩ | 24.28 mΩ |
| 6 | 3 | MHz | Circular | 66.89 mΩ | 28.47 mΩ |

It can be learned from the measurement results that when the number of twisting times is four, and the number of wires 30a in the first twisting is 10, the alternating current impedance is smaller. Compared with “the number of twisting times is two, and the number of wires 30a in the first twisting is 45”, the alternating current impedance decreases significantly. Therefore, a small number (for example, 3 to 20) of wires are used for the first twisting of the wire strand of the induction coil, and increasing the number of twisting times (for example, at least three times) can improve electromagnetic coupling efficiency, and improve a heating speed of the susceptor during work, so that the aerosol generation apparatus can generate the aerosol in a very short time after start-up, to meet a use requirement that the aerosol generation apparatus including the liquid substrate can be used for inhalation almost immediately after the start-up.

In addition, in the twisting process of “the number of twisting times is four, and the number of wires 30a in the first twisting is 10”, there is no wire breakage. However, in the twisting process of “the number of twisting times is two, and the number of wires 30a in the first twisting is 45”, there is wire breakage.

FIG. 15 is a schematic diagram of another induction coil according to an implementation of this application.

As shown in FIG. 15, the induction coil 21a is constructed into a planar spiral coil. A wire material of the planar spiral coil is also formed by twisting a plurality of wires 30a a plurality of times. The number of wires 30a in the first twisting ranges from 3 to 20. For the number of twisting times, preferably, twisting process is used three or four times.

The planar spiral coil may be arranged in a longitudinal direction perpendicular to the aerosol generation apparatus 100, or may be arranged in a longitudinal direction of the aerosol generation apparatus 100. The planar spiral coil may be supported by a sheet-like or plate-like support member parallel with a planar induction coil 21a, or may be embedded into another component.

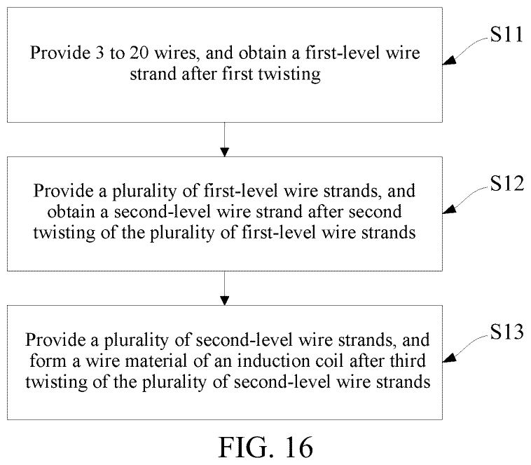

FIG. 16 is a schematic diagram of a method for forming an induction coil according to an implementation of this application.

As shown in FIG. 16, the method includes:

Step S11: Provide 3 to 20 wires, and obtain a first-level wire strand after first twisting.

Step S12: Provide a plurality of first-level wire strands, and obtain a second-level wire strand after second twisting of the plurality of first-level wire strands.

Each first-level wire strand in the plurality of first-level wire strands may have a same number of wires, or may have different numbers of wires.

Step S13: Provide a plurality of second-level wire strands, and form a wire material of the induction coil after third twisting of the plurality of second-level wire strands.

In an example, the method further includes:
obtaining a third-level wire strands after the third twisting of the plurality of second-level wire strands; and
providing a plurality of third-level wire strands, and forming the wire material of the induction coil after fourth twisting of the plurality of third-level wire strands.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing description, and all the improvements and modifications shall fall within the protection scope of the attached claims of this application.

1. An aerosol generation apparatus, comprising:
an induction coil, configured to generate a changing magnetic field; and
a susceptor, configured to be induced to produce heat in the changing magnetic field, to heat an aerosol generation substrate to generate an aerosol, wherein
a wire material of the induction coil comprises at least two wire cores; and the wire core comprises at least two conductive wires.

2. The aerosol generation apparatus according to claim 1, wherein a cross section of the wire material of the induction coil is circular or rectangular.

3. The aerosol generation apparatus according to claim 1, wherein the induction coil is constructed into a solenoid coil or a planar spiral coil.

4. The aerosol generation apparatus according to claim 1, wherein the wire material of the induction coil comprises 3 to 10 wire cores.

5. The aerosol generation apparatus according to claim 1, wherein the conductive wire has a diameter ranging from 0.02 mm to 0.2 mm.

6. The aerosol generation apparatus according to claim 1, wherein the conductive wire has an elongation at break ranging from 1% to 6%.

7. The aerosol generation apparatus according to claim 1, wherein the wire core has an ultimate tensile strength of more than 50 MPa.

8. The aerosol generation apparatus according to claim 1, wherein the at least two conductive wires in the wire core are twisted;
and/or the at least two wire cores in the wire material of the induction coil are twisted.

9. The aerosol generation apparatus according to claim 1, wherein the wire core further comprises a first cladding layer configured to cover the at least two conductive wires;
and/or the induction coil further comprises a second cladding layer configured to cover the at least two wire cores.

10. The aerosol generation apparatus according to claim 1, wherein the aerosol generation substrate comprises a liquid substrate, the susceptor is configured to heat the liquid substrate to generate an aerosol, each wire core is formed by twisting a plurality of conductive wires one or more times, and a number of conductive wires used in first twisting of the plurality of conductive wires ranges from 3 to 20.

11. The aerosol generation apparatus according to claim 10, wherein the wire core is formed by twisting a plurality of conductive wires three or four times.

12. The aerosol generation apparatus according to claim 10, wherein a diameter of the conductive wire ranges from 0.01 mm to 0.05 mm.

13. The aerosol generation apparatus according to claim 10, wherein the wire material of the induction coil comprises 500 to 2000 conductive wires.

14. The aerosol generation apparatus according to claim 10, wherein a working frequency provided for the induction coil ranges from 500 KHz to 3 MHz.

15. The aerosol generation apparatus according to claim 10, wherein the induction coil is formed into a solenoid coil, and a number of turns of the solenoid coil ranges from 4 to 20.

16. The aerosol generation apparatus according to claim 15, wherein a cross section of a hollow part of the solenoid coil is elliptical.

17. The aerosol generation apparatus according to claim 15, wherein a spacing between adjacent turns of the solenoid coil ranges from 0.1 mm to 2 mm.

18. An induction coil used in an aerosol generation apparatus, the induction coil being configured to generate a changing magnetic field, wherein a wire material of the induction coil comprises a plurality of wire cores, and each wire core is formed by twisting a plurality of conductive wires one or more times, wherein a number of conductive wires used in first twisting of the plurality of conductive wires ranges from 3 to 20.

19. A preparation method for an induction coil used in an aerosol generation apparatus, comprising:
providing 3 to 20 conductive wires, and obtaining a first-level wire core after first twisting;
providing a plurality of first-level wire cores, and obtaining a second-level wire core after second twisting of the plurality of first-level wire cores; and
providing a plurality of second-level wire cores, and forming a wire material of the induction coil after third twisting of the plurality of second-level wire cores.

20. The method according to claim 19, further comprising:
obtaining a third-level wire core after the third twisting of the plurality of second-level wire cores; and
providing a plurality of third-level wire cores, and forming a wire material of the induction coil after fourth twisting of the plurality of third-level wire cores.
